(19) United States
(12) Patent Application Publication
(10) Pub. No.: US 2020/0335801 A1
(43) Pub. Date: Oct. 22, 2020

(54) BIPOLAR PLATE OF PROTON EXCHANGE MEMBRANE FUEL CELL AND METHOD OF PREPARING SAME

(71) Applicant: SHENZHEN SOUTHERNTECH FUEL CELL CO., LTD., Shenzhen (CN)

(72) Inventors: Hui LI, Vancouver (CA); Bing WEI, Shenzhen (CN); Yong DING, Shenzhen (CN); Yajun WANG, Shenzhen (CN); Haijiang WANG, Vancouver (CA)

(21) Appl. No.: 16/877,002

(22) Filed: May 18, 2020

Related U.S. Application Data
(63) Continuation of application No. PCT/CN2017/117288, filed on Dec. 19, 2017.

(30) Foreign Application Priority Data
Nov. 20, 2017 (CN) 201711156145.0

(51) Int. Cl. H01M 8/0226; H01M 8/0221

(52) U.S. Cl. CPC H01M 8/0226; H01M 8/0221

(57) ABSTRACT

A bipolar plate of a proton exchange membrane fuel cell is prepared from graphite powder, thermosetting resin and an electrically conductive polymer. The electrically conductive polymer has good electrically conductive properties, and can be cured by heating, which improves the strength and air tightness while ensuring the electrical conductivity of the graphite/thermosetting resin composite bipolar plate. A method of preparing the bipolar plate is further provided, including dispersing the graphite powder in a first organic solvent to obtain a first mixture; dispersing the electrically conductive polymer in a second organic solvent to obtain a second mixture; uniformly mixing the first mixture and the second mixture followed by heating and drying to obtain a powder mixture; mixing, the powder mixture and the thermosetting resin followed by ball milling, thermal press curing, cooling and demolding to obtain the bipolar plate.

### CROSS-REFERENCE TO RELATED APPLICATIONS

This application is a continuation of International Patent Application No. PCT/CN2017/117288, filed on Dec. 19, 2017, which claims the benefit of priority from Chinese Patent Application No. 201711156145.0, filed on Nov. 20, 2017. The content of the aforementioned applications, including any intervening amendments thereto, is incorporated herein by reference.

### TECHNICAL FIELD

The present application relates to electrochemical materials and the related devices, and more particularly to a bipolar plate of a proton exchange membrane fuel cell and a method of preparing the same.

### BACKGROUND

A Proton Exchange Membrane (PEM) Fuel Cell is an electrochemical conversion device to transform the chemical energy liberated during the electrochemical reaction of hydrogen and oxygen to electrical energy. A bipolar plate is a key component of the fuel cell and contributes to 30% of the cost, 80% of the weight and almost the entire volume of the fuel cell. In order to allow the bipolar plate function better in separating an oxidizing agent and a reducing agent, collecting the current, providing flow channels for a coolant and constituting a backbone of a stack in the fuel cell, the bipolar plate of the fuel cell is required to have high electrical conductivity and good bending strength, corrosion resistance and air tightness.

Currently, conventional bipolar plates are divided into three types: a graphite bipolar plate, a metallic bipolar plate and a composite bipolar plate, where the metallic bipolar plate has good electrical and thermal conductivity. Even if the thickness is reduced to 0.1 mm, the metallic bipolar plate still has good air tightness. Moreover, gas flow channels of the metallic bipolar plate are formed through a stamping process, so that the metallic bipolar plate can be produced in bulk, thereby increasing a power/volume ratio and reducing the manufacturing cost of the fuel cell. However, a forming mold of the metallic bipolar plate is highly required in precision, which leads to an increased cost. Metallic substrates, especially surfaces of the metallic substrates, are required to be specially treated to have better stable chemical properties, so that the metallic bipolar plate has improved corrosion resistance. Otherwise, the metallic bipolar plate is prone to corrosion or even rust hole, shortening the service life of the battery or even causing catastrophic damages.

The graphite bipolar plate has good electrical and thermal conductivity, and stable chemical properties. However, flow channels of the graphite bipolar plate are generally processed through conventional machining methods which are time-consuming and inefficient, and have large cutting tool consumption, making pure graphite bipolar plates have relatively high processing cost which is even higher than material cost. On the other hand, due to the brittleness, the graphite bipolar plate is required to be thick to ensure the blending strength and air tightness, so it is not possible to improve the stack in the volume power density and mass power density. Therefore, it is required to find alternatives to existing preparation processes and methods, so that the fuel cell can be commercialized.

Currently, various composite bipolar plates, such as a metal/graphite composite bipolar plate, a natural graphite/resin composite bipolar plate and an expanded composite graphite (EG)/resin bipolar plate, are under development, increasing studies and experiments are being conducted to develop a novel composite bipolar plate which combines the advantages of the metallic bipolar plate and the graphite bipolar plate and does not have the shortcomings of the existing bipolar plates.

However, the existing composite bipolar plates improved by all the methods and techniques are still unsatisfactory in practical use due especially to low electrical conductivity and poor strength.

### SUMMARY

Given the above, this application provides a composition for preparing an electrically conductive material and a method of preparing the same; a bipolar plate of a proton exchange membrane fuel cell and a method of preparing the same; and the proton exchange membrane fuel cell to overcome the shortcomings in the prior art.

The technical solutions are described as follows.

The application provides a bipolar plate of a proton exchange membrane fuel cell, the bipolar plate being prepared from 5%-30% by weight of thermosetting resin: 60%-90% by weight of graphite powder and 1%-10% by weight of an electrically conductive polymer.

In some embodiments, the bipolar plate of the proton exchange membrane fuel cell is prepared from 10%-25% by weight of the thermosetting resin, 69%-80% by weight of the graphite powder and 2%-10% by weight of the electrically conductive polymer.

In some embodiments, the bipolar plate of the proton exchange membrane fuel cell is prepared from 10%-20% by weight of the thermosetting resin, 73%-80% by weight of the graphite powder and 5%-10% by weight of the electrically conductive polymer.

In some embodiments, the bipolar plate of the proton exchange membrane fuel cell is prepared from 15%-30% by weight of the thermosetting resin, 69%-80% by weight of the graphite powder and 1%-5% by weight of the electrically conductive polymer.

In some embodiments, the thermosetting resin is epoxy resin or phenol resin.

In some embodiments, the electrically conductive polymer is any one of polypyrrole, polyacetylene, poly (p-phenylene) or a poly(3,4-ethylendioxythiophene (Pedot) electrically conductive liquid.

The application provides a composition for preparing electrically conductive materials, including:

5%-30% by weight of the thermosetting resin; 60%-90% by weight of the graphite powder and 1%-10% by weight of the electrically conductive polymer.

In some embodiments, the composition is prepared from 10%-25% by weight of the thermosetting resin, 69%-80% by weight of the graphite powder and 2%-10% by weight of the electrically conductive polymer.

In some embodiments, the composition is prepared from 10%-20% by weight of the thermosetting resin, 73%-80% by weight of the graphite powder and 5%-10% by weight of the electrically conductive polymer.

In some embodiments, the composition is prepared from 15%-30% by weight of the thermosetting resin, 69%-80% by weight of the graphite powder and 1%-5% by weight of the electrically conductive polymer.

The application further provides a method of preparing the composition, including:

1) dispersing the graphite powder in a first organic solvent that is volatile to obtain a first mixture;

2) dispersing the electrically conductive polymer in a second organic solvent that is volatile to obtain a second mixture;

3) uniformly mixing the first mixture and the second mixture followed by heating and drying to obtain a powder mixture; and

4) mixing the powder mixture and the thermosetting resin followed by ball milling to obtain the composition.

The application further provides a method of preparing the bipolar plate of the proton exchange membrane fuel cell, including:

1) dispersing the graphite powder in a first organic solvent that is volatile to obtain a first mixture;

2) dispersing the electrically conductive polymer in a second organic solvent that is volatile to obtain a second mixture;

3) uniformly mixing the first mixture and the second mixture followed by heating and drying to obtain a powder mixture;

4) mixing the powder mixture and the thermosetting resin followed by ball milling to obtain a third mixture; and

5) subjecting the third mixture to thermal press curing followed by cooling and demolding to obtain the bipolar plate.

In some embodiments, the first organic solvent and the second organic solvent serve as a volatile solvent to allow the graphite powder and the electrically conductive polymer to be sufficiently mixed.

In some embodiments, the first organic solvent and the second organic solvent have the same composition.

In some embodiments, the first organic solvent and the second organic solvent are both an ethanol solution which is a mixed solution of ethanol and water.

In some embodiments, the first organic solvent and the second organic solvent are respectively a first ethanol solution and a second ethanol solution which have different volume ratios of ethanol to water.

In some embodiments, the first organic solvent and the second organic solvent are respectively a first ethanol solution and a second ethanol solution which have the same volume ratio of ethanol to water.

In some embodiments, the first organic solvent and the second organic solvent are both an ethanol solution which has a volume ratio of ethanol to water in a range from 3:1 to 6:1.

In some embodiments, the first organic solvent in step (1) and the second organic solvent in step (2) are both an ethanol solution which has a volume ratio of ethanol to water of 4:1.

In some embodiments, the mixing in steps (1)-(3) is performed, through any one of magnetic stirring, mechanical stirring and ultrasonic vibration.

The application further provides a method of preparing the bipolar plate of the proton exchange membrane fuel cell, including:

1) dispersing the graphite powder in ant ethanol solution through, magnetic stirring to obtain a first mixture;

2) dispersing the electrically conductive polymer in the ethanol solution through magnetic stirring to obtain a second mixture;

3) mixing the first mixture and the second mixture through magnetic stirring followed by heating and drying to obtain a powder mixture;

4) mixing the powder mixture and the thermosetting resin followed by ball milling to obtain a third mixture; and

5) subjecting the third mixture to thermal press curing followed by cooling and demolding, to obtain the bipolar plate.

In some embodiments, a volume ratio of ethanol to water in the ethanol solution in steps (1) and (2) is 4:1

In some embodiments, the magnetic stirring m steps (1)-(3) is performed for 10-60 min.

In some embodiments, the heating in step (3) is performed at a temperature of 40-50° C.

In some embodiments, the ball milling in step (4) is performed at speed of 150-300 rpm for 1-3 h.

In some embodiments, in step (5), the third mixture is placed in a hot press to perform the thermal press curing; and the thermal press curing is perfumed at a temperature of 150-200° C. and under a pressure of 20-40 T for 10-40 min.

In some embodiments, the thermal press curing applied to the third mixture in step (5) includes different stages.

In some embodiments, the thermal press curing applied to the third mixture in step (5) includes four stages, where a first stage is performed at a temperature of 50-70° C. under a pressure of 12-18 for 8-15 min; a second stage is performed at a temperature of 100-140° C. under a pressure of 18-22 T for 8-15 min; a third stage is performed at a temperature of 150-170° C. under a pressure of 22-28 for 8-15 min; and a fourth stage is performed at a temperature of 170-200° C. under a pressure of 28-40 T for 8-15 min.

The application further provides a proton exchange membrane fuel cell using any one of the above-mentioned bipolar plates.

Compared to the prior art, the bipolar plate of the proton exchange membrane fuel cell provided in this application has the following beneficial effects.

The inventor has found that it is the following technical problems that cause the shortcomings of the existing bipolar plates.

1) Phenolic resin is dielectric, so that the electrical conductivity and the bending strength of the bipolar plates cannot achieve the requirements of United States Department of Energy if the phenolic resin is only mixed with the graphite powder; and

2) Three-phase interfaces are not cohesive if other electrically conductive filers, such as carbon black, carbon fiber and carbon nanotubes, are added into the mixture of the phenolic resin and the graphite powder.

The application aims to provide a formula and a processing method for improving a bipolar plate in the electrical conductivity, bending strength and air tightness, filling in the blank spots on the current research map.

The composite bipolar plate of the application is prepared from the graphite powder, the thermosetting resin and the electrically conductive polymer, where the electrically conductive polymer has good electrically conductive properties, and can be cured by heating, which improves the strength and air tightness while ensuring the electrical conductivity of the graphite/thermosetting resin composite bipolar plate, thereby preparing the composite bipolar plate with high electric conductively, strength and air tightness. The bipolar plate of the proton exchange membrane fuel cell prepared in the application has low cos and simple manufacturing process and can be readily produced in an automated manner.

The bipolar plate of the proton exchange membrane fuel cell prepared in the application has an electrical conductivity of 558 S/cm and a bending strength of 72 MPa.

In some embodiments, the thermosetting resin is epoxy resin or phenol resin.

In some embodiments, the electrically conductive polymer is polypyrrole, poly acetylene, poly(p-phenylene), or a Pedot electrically conductive liquid.

It can be understood that the Pedot electrically conductive liquid is a polymer of 3,4-ethylenedioxythiophene monomer (EDOT). Pedot is widely used in solar cell materials due to its simple molecular structure, small energy gap and high electrical conductivity.

In some embodiments, press molding is carried out in the method of preparing the bipolar plate of the proton exchange membrane fuel cell.

It can be understood that the composite material is formed mainly by injection molding, impregnating a graphite plate with resin after cold pressing, and hot press molding. However, the graphite content is limited in the injection molding, and thus the composite material prepared by the injection molding fails to have desirable electrically conductive performance.

During the press molding, powdery raw materials are mixed and added into a mold to fill an entire cavity of the mold under flowing, and then are shaped under heating and pressure. There are two methods to press the raw materials in the mold: dry mixing method and wet mixing method, where the wet mixing method is carried out by firstly dissolving a polymeric binder in an organic solvent to obtain a mixed solution, and then dispersing the graphite in the mixed solution to obtain a slurry, and removing the solvent of the slurry followed by press molding to obtain the bipolar plate. The drying mixing method is carried out by dry mixing polymer powder and electrically conductive particles such as graphite without the addition of a solvent followed by press molding or injection molding to obtain the bipolar plate.

It can be understood that the composite bipolar plate is mainly composed of a binder and an electrically conductive filler. The binder is generally resin, which is divided into thermosetting resin and thermoplastic resin. The electrically conductive filler is graphite (such as expanded graphite, natural flake graphite and artificial graphite), carbon black, carbon fibers or carbon nanotubes. According to years of research, the inventor adopts graphite powder and the thermosetting resin.

The composition of the application can be used to prepare an electrically conductive material through hot press molding, and the prepared electrically conductive material, can be further used in the preparation of the bipolar plate of the proton exchange membrane fuel cell and other materials for other purposes. In addition, since the bipolar plate of the application has improved properties, the proton exchange membrane fuel cell using the bipolar plate of the application is also improved in multiple properties.

In summary, the composition for preparing the electrically conductive material and the method of preparing the same, the bipolar plate of the proton exchange membrane fuel cell and the method of preparing the same, and the proton exchange membrane fuel cell provided in the application have lots of advantages and values as mentioned above. The products and the preparation methods of the application are not disclosed or used in the art, and thus are inventive. The application has more functions and practical effects over the prior art so the application is industrially applicable and has a wide range of industrial values.

### DETAILED DESCRIPTION OF EMBODIMENTS

This application will be further described below with reference to the embodiments. Any adjustments and modifications can be made based on various embodiments disclosed herein. However, it should be understood that these embodiments are not intended to limit the disclosure, and all adjustments, replacements and/or alternatives made without departing from the spirit should fall within the scope of the application.

In the following embodiments, the term “include” or “may include” indicates the presence of the disclosed functions, operations or elements, and does not limit the addition of other functions, operations or elements.

In the following embodiments, the term “or” or “at least one of A and B” means any combination of elements listed therein. For example, the term “A or B” or “at least one of A and B” may include A, B or a combination of A and B.

Expressions such as “first” and “second” used herein are intended to illustrate various components in various embodiments. For example, the expressions as mentioned above are not intended to limit the order and/or importance of the scribed elements, and are merely to distinguish one element from another. For example, a first user device and a second user device refer to two different devices, although both are user devices. For example, without departing from the scope of the various embodiments of the disclosure, a first element can refer to a second element, or a second device can refer to a first element.

It should be understood that if a first component is described to be connected to a second component, it means that the first component and the second component may be directly connected, or may be indirectly connected through a third component. In contrast, if the first component is described to be directly connected to the second component, it means that the first component and the second component can be connected without the involvement of the third component.

Terms used in the various embodiments of the disclosure are merely illustrative and not intended to limit the application. Unless otherwise specified, the singular form may also include a plural form. Unless otherwise specified, all terms, including technical and scientific terms, used herein have the same meaning as commonly understood by, those skilled in the art. The terms (such as those defined in the commonly used dictionaries) will be interpreted to the same meanings as the contextual meaning in the relevant technical field and will not be interpreted to an idealized or excessively formal meaning unless a definition has been clearly made in the application.

This application provides a bipolar plate of a proton exchange membrane fuel cell, including;

5%-30% by weight of thermosetting resin; 60%-90% by weight of graphite powder and 1%-10% by weight of an electrically conductive polymer.

In some embodiments, the bipolar plate of the proton exchange membrane fuel cell is prepared from 10%-25% by weight of the thermosetting resin, 69%-80% by weight of the graphite powder and 2%-10% by weight of the electrically conductive polymer.

In some embodiments, the bipolar plate of the proton exchange membrane fuel cell is prepared from 10%-20% by weight of the thermosetting resin, 73%-80% by weight of the graphite powder and 5%-10% by weight of the electrically conductive polymer.

In some embodiments, the bipolar plate of the proton exchange membrane fuel cell is prepared from 15%-30% by weight of the thermosetting resin, 69%-80% by weight of the graphite powder and 1%-5% by weight of the electrically conductive polymer.

In some embodiments, the thermosetting resin is epoxy resin or phenol resin.

In some embodiments, the electrically conductive polymer is any one of polypyrrole, polyacetylene, polyp-phenylene) and a poly(3,4-ethylendioxythiophene) (Pedot) electrically conductive liquid.

The application further provides a composition for preparing electrically conductive materials. The composition is prepared from 5%-30% by weight of the thermosetting resin; 60%-90% by weight of the graphite powder and 1%-10% by weight of the electrically conductive polymer.

In some embodiments, the composition is prepared from 10%-25% by weight of the thermosetting resin, 6914-80% by weight of the graphite powder and 2%-10% by weight of the electrically conductive polymer.

In some embodiments, the composition is prepared from 10%-20% by weight of the thermosetting resin, 73%-80% by weight of the graphite powder and 5%-10% by weight of the electrically conductive polymer.

In some embodiments, the composition is prepared from 15%-30% by weight of the thermosetting resin, 69%-80% by weight of the graphite powder and 1%-5% by weight of the electrically conductive polymer.

In an embodiment of the application, a method of preparing the composition is provided, including:

1) dispersing the graphite powder in a first organic solvent that is volatile to obtain a first mixture;

2) dispersing the electrically conductive polymer in a second organic solvent that is volatile to obtain a second mixture;

3) uniformly mixing the first mixture and the second mixture followed by heating and drying to obtain a powder mixture; and

4) mixing the powder mixture and the thermosetting resin followed by ball milling to obtain the composition.

In an embodiment of the application, a method of preparing the bipolar plate of the proton exchange membrane fuel cell is provided, including:

1) dispersing the graphite powder in a first organic solvent that is volatile to obtain a first mixture;

2) dispersing the electrically conductive polymer in a second organic solvent that is volatile to obtain a second mixture;

3) uniformly mixing the first mixture and the second mixture followed by heating and drying to obtain a powder mixture;

4) mixing the powder mixture and the thermosetting resin followed by ball milling to obtain a third mixture; and

5) subjecting the third mixture to thermal press curing followed by cooling and demolding to obtain the bipolar plate.

In some embodiments, the first organic solvent and the second organic solvent functions as a volatile solvent to allow the graphite powder and the electrically conductive polymer to be sufficiently mixed. The first and second organic solvents are methanol, ethanol, etc.

In some embodiments, the first and second organic solvents have the same composition.

In some embodiments, the first and second organic solvents are both an ethanol solution, which is a mixed solution of ethanol and water.

In the case that the electrically conductive polymer is the Pedot electrically conductive liquid, the Pedot electrically conductive liquid can be fully dispersed in water since it is water-soluble. However, water cannot evaporate rapidly during drying, and an absolute ethanol solution alone fails to completely dissolve the Pedot. So, the mixed solution of ethanol and water is adopted to facilitate the rapid evaporation of the solvent and complete dissolution of the Pedot.

In some embodiments, the first and second organic solvents are respectively a first ethanol solution and a second ethanol solution which ha different volume ratios of ethanol to water.

In some embodiments, the first and second organic solvents are respectively a first ethanol solution and a second ethanol solution which have the same volume ratio of ethanol to water.

In some embodiments, the first and second organic solvents are both an ethanol solution which has a volume ratio of ethanol to water ranging from 3:1 to 6:1.

In some embodiments, the organic solvents in steps (1) and (2) are both an ethanol solution which has a volume ratio of ethanol to water of 4:1.

In some embodiments, the mixing in steps (1)-(3) is performed through any one of magnetic stirring, mechanical stirring and ultrasonic vibration.

In an embodiment of the application, a method of preparing the bipolar plate of the proton exchange membrane fuel cell is provided, including;

1) dispersing the graphite powder in an ethanol solution through magnetic stirring to obtain a first mixture;

2) dispersing the electrically conductive polymer in the ethanol solution through magnetic stirring to obtain a second mixture;

3) mixing the first mixture and the second mixture through magnetic stirring followed by heating and drying to obtain a powder mixture;

4) mixing the powder mixture and the thermosetting resin followed by ball milling to obtain a third mixture; and

5) subjecting the third mixture to thermal press curing followed by cooling and demolding, to obtain the bipolar plate.

The application aims to provide a formula and a processing method for improving a bipolar plate in electrical conductivity, bending strength and air tightness, filling in the blank spots on the current research map.

In an embodiment, the composite bipolar plate is prepared from the graphite powder, the thermosetting resin and the electrically conductive polymer. Where, the electrically conductive polymer has good electrically conductive properties, and can be cured by heating, which improves the strength and alt tightness while ensuring the electrical conductivity of the graphite/thermosetting resin composite bipolar plate, thereby preparing the composite bipolar plate with high electric conductively, strength and air tightness. The bipolar plate of the proton exchange membrane fuel cell prepared in the application has low cost and simple manufacturing process and can be readily produced in an automated mariner.

The bipolar plate of the proton exchange membrane fuel cell prepared in this embodiment has an electrical conductivity of 558 S/cm and a bending strength of 72 MPa.

In some embodiments, a volume ratio of ethanol to water in the ethanol solution in steps (1) and (2) is 4:1

In some embodiments, the magnetic stifling in steps (1)-(3) is performed for 10-60 min.

In some embodiments, the heating in step (3) is performed at a temperature of 40-50° C. Ethanol begins to volatilize at a temperature of about 20° C. Heating can promote the evaporation of ethanol. However, when the temperature is too high, the properties of the Pedot will be affected.

In some embodiments, the ball milling in step (4) is performed at speed of 150-300 rpm fur 1-3 h.

The ball milling is performed to further grind resin powders, and fully mix the graphite with the ground resin powders.

In some embodiments, in step (5), the third mixture is placed in a hot press to perform the thermal press curing; and the thermal press curing is performed at a temperature of 150-200° C., under a pressure of 20-40 T for 10-40 min.

In some embodiments, the thermal press curing applied to the third mixture in step (5) comprises different stages.

Since hot pressing has different stages, powders in the mold can treated in the different stages to have less air holes, so as to allow for a better combination among the powders, thereby reducing the porosity and improving the strength and density.

In some embodiments. the thermal press curing applied to the third mixture in step (5) includes four stages, where a first stage is performed at a temperature of 50-70° C. under a pressure of 12-18 T for 8-15 min; a second stage is performed at a temperature of 100-140° C. under a pressure of 18-22 T for 8-15 min; a third stage is performed at a temperature of 150-170° C. under a pressure of 22-28 T for min; and a fourth stage is performed at a temperature of 170-200° C. under a pressure of 28-40 T for 8-15 min.

The application further provides a proton exchange membrane fuel cell using any one of the above-mentioned bipolar plates.

The following embodiments are intended to further illustrate, but not to limit the invention.

Materials: graphite powder having a purity of 99% and a particle size of 100 mesh (Qingdao Tengshengda Carbon Graphite Co., Ltd.); Pedot electrically conductive liquid (Shanghai Maxtor Technique Co Ltd.); phenolic resin powder, Type 3006 (Shandong Laiwu Runda. New material Co., Ltd.); and epoxy resin powder (Guangzhou Rongsheng Chemical Co., Ltd.).

### EXAMPLE 1

Provided herein was a bipolar plate of a proton exchange membrane fuel cell, which was prepared by the following steps.

8.5 g of graphite powder was uniformly dispersed in an ethanol solution under magnetic stirring for 10 min to obtain a first mixture.

0.1 g of a Pedot electrically conductive liquid was uniformly dispersed in the ethanol solution under magnetic stirring for 10 min to obtain a second mixture; where a volume ratio of ethanol to water in the ethanol solution was 4:1.

The first mixture and the second mixture were mixed followed by magnetic stirring for 10 min while heating at 40° C. until the mixture was dried. The dried mixture was placed in an oven to further be dried to obtain a powder mixture.

Subsequently, the powder mixture and 1.4 g of phenolic resin powder were mixed through ball milling at a speed of 221 rpm for 2 h to obtain a third mixture.

The third mixture was placed in a mold to be subjected to thermal press curing in four stages, where a first stage was performed at a temperature of 60° C. under a pressure of 15 T for 10 min; a second stage was performed at a temperature of 120° C. under a pressure of 20 T for 10 min; a third stage was performed at a temperature of 160° C. under a pressure of 25 T for 10 mm; and a fourth stage was performed at a temperature of 180° C. under a pressure of 30 T for 10 min. Finally, the cured mixture was cooled and demolded under a pressure of 20 T to obtain the bipolar plate.

### EXAMPLE 2

Provided herein was a bipolar plate of a proton exchange membrane fuel cell, which was prepared by the following steps.

8.3 g of graphite powder was uniformly dispersed in an ethanol solution under magnetic stirring for 10 min to obtain a first mixture.

0.2 g of a Pedot electrically conductive liquid was uniformly dispersed in the ethanol solution under magnetic stiffing for 60 min to obtain a second mixture; where a volume ratio of ethanol to water in the ethanol solution was 4:1.

The first mixture and the second mixture were mixed followed by magnetic stirring for 60 min while heating at 50° C. until the mixture was dried. The dried mixture was placed in an oven to further be dried to obtain a powder mixture.

Subsequently, the powder mixture and 1.5 g of phenolic resin powder were mixed through ball milling at a speed of 150 rpm for 1 h to obtain a third mixture.

The third mixture was placed in a mold to be subjected to thermal press curing in four stages, where a first stage was performed at a temperature of 60° C. under a pressure of 15 T for 10 min; a second stage was performed at a temperature of 120° C. under a pressure of 20 T for 10 min; a third stage was performed at a temperature of 160° C. under a pressure of 25 T for 10 min; and a fourth stage was performed at a temperature of 180° C. under a pressure of 30 T for 10 min. Finally, the cured mixture was cooled and demolded under a pressure of 20 T to obtain the bipolar plate.

### EXAMPLE 3

Provided herein was a bipolar plate of a proton exchange membrane fuel cell, which was prepared by the following steps.

8 g of graphite powder was uniformly dispersed in an ethanol solution under magnetic stirring for 10 min to obtain a first mixture.

0.3 g of a Pedot electrically conductive liquid was uniformly dispersed in the ethanol solution under magnetic stirring for 30 min to obtain a second mixture; where a volume ratio of ethanol to water in the ethanol solution was 4:1.

The first mixture and the second mixture were mixed followed by magnetic stirring for 30 min while heating at 40° C. until the mixture was dried. The dried mixture was placed in an oven to further be dried to obtain a powder mixture.

Subsequently, the powder mixture and 1.7 g of phenolic resin powder were mixed through ball milling at a speed of 300 rpm for 3 h to obtain a third mixture.

The third mixture was placed in a mold to he subjected. to thermal press curing in. four stages, where a first stage was performed at a temperature of 60° C.; under a pressure of 15 T for 10 min; a second stage was performed at a temperature of 120° C. under a pressure of 20 T for 10 min, a third stage was performed at a temperature of 170° C. under a pressure of 25 T for 10 min; and a fourth stage was performed at a temperature of 200° C. under a pressure of 30 T for 10 min. Finally, the cured mixture was cooled and demolded under a pressure of 20 T to obtain the bipolar plate.

### EXAMPLE 4

Provided herein was a bipolar plate of a proton exchange membrane fuel cell, which was prepared by the following steps.

6.9 g of graphite powder was uniformly dispersed in an ethanol solution under magnetic stirring for 10 min to obtain a first mixture.

0.1 g of a Pedot electrically conductive liquid was uniformly dispersed in the ethanol solution under mimetic stirring for 45 min to obtain a second mixture; where a volume ratio of ethanol to water in the ethanol solution was 4:1.

The first mixture and the second mixture were mixed followed b magnetic stirring for 45 min while heating at 45° C. until the mixture was dried. The dried mixture was placed in an oven to further be dried to obtain a powder mixture.

Subsequently, the powder mixture and 3.0 g of phenolic resin powder were mixed through ball milling at a speed of 200 rpm for 2 h to obtain a third mixture.

The third mixture was placed in a mold to be subjected to thermal press curing in four stages, where a first stage was performed at a temperature of 60° C. under a pressure of 15 T for 10 min; a second stage was performed at a temperature of 120° C. under a pressure of 20 T for 10 min; a third stage was performed at a temperature of 170° C. under a pressure of 25 T for 10 min; and a fourth stage was performed at a temperature of 200° C. under a pressure of 30 T for 10 min. Finally, the cured mixture was cooled and demolded under a pressure of 20 T to obtain the bipolar plate.

### EXAMPLE 5

Provided herein was a bipolar plate of a proton exchange membrane fuel cell, which was prepared by the following steps.

8.0 g of graphite powder was uniformly dispersed in an ethanol solution under magnetic stifling for 10 min to obtain a first mixture.

1 g of a Pedot electrically conductive liquid was uniformly dispersed in the ethanol solution under magnetic stirring for 35 min to obtain a second mixture; where a volume ratio of ethanol to water in the ethanol solution was 4:1.

The first mixture and the second mixture were mixed followed by magnetic stirring for 35 min while heating at 48° C. until the mixture was dried. The dried mixture was placed in an oven to thither be dried to obtain a powder mixture.

Subsequently, the powder mixture and 1.0 g of phenolic resin powder were mixed through ball milling at a speed of 220 rpm for 2.5 h to obtain a third mixture.

The third mixture was placed in a mold to be subjected to thermal press curing in four stages, where a first stage was performed at a temperature of 60° C. under a pressure of 15 for 10 min; a second stage was performed at a temperature of 120° C. under a pressure of 20 T for 10 min; a third stage was performed at a temperature of 160° C. under a pressure of 25 for 10 min; and a fourth stage was performed at a temperature of 180° C. under a pressure of 30 T for 10 min. Finally, the cured mixture was cooled and demolded under a pressure of 20 T to obtain the bipolar plate.

### EXAMPLE 6

Provided herein was a bipolar plate of a proton exchange membrane fuel cell, which was prepared by the following steps.

8.0 g of graphite powder was uniformly dispersed in an ethanol solution under magnetic stirring for 10 min to obtain a first mixture.

0.5 g of a Pedot electrically conductive liquid was uniformly dispersed in the ethanol solution under magnetic stirring for 35 min to obtain a second mixture; where a volume ratio of ethanol to water in the ethanol solution was 4:1.

The first mixture and the second mixture were mixed followed by magnetic stirring for 35 min while heating at 48° C. until the mixture was dried. The dried mixture was placed in an oven to further be dried to obtain a powder mixture.

Subsequently, the powder mixture and 1.5 g of phenolic resin powder were mixed through ball milling at a speed of 220 rpm for 2.5 h to obtain a third mixture.

The third mixture was placed in a mold to be subjected to thermal press curing in four stages, where a first stage was performed at a temperature of 60° C. under a pressure of 15 T for 10 min; a second stage was performed at a temperature of 120° C. under a pressure of 20 T for 10 min; a third stage was performed at a temperature of 160° C. under a pressure of 25 T for 10 min; and a fourth stage was performed at a temperature of 180° C. under a pressure of 30 T for 10 min. Finally, the cured mixture was cooled and demolded under a pressure of 20 T to obtain the bipolar plate.

### EXAMPLE 7

Provided herein was a bipolar plate of a proton exchange membrane fuel cell, which was prepared by the following steps.

7.7 g of graphite powder was uniformly dispersed in an ethanol solution under magnetic stirring for 10 min to obtain a first mixture.

0.3 g of a Pedot electrically conductive liquid was uniformly dispersed in the ethanol solution under magnetic stirring for 35 min to obtain a second mixture; where a volume ratio of ethanol to water in the ethanol solution was 4:1.

The first mixture and the second mixture were mixed followed by magnetic stirring for 35 min while heating at 48° C. until the mixture was dried. The dried mixture was placed in an oven to further be dried to obtain a powder mixture.

Subsequently, the powder mixture and 2 g of phenolic resin powder were mixed through tall milling at a speed of 220 rpm for 2.5 h to obtain a third mixture.

The third mixture was placed in a mold to be subjected to thermal press curing in four stages, where a first stage was performed at a temperature of 660° C. under a pressure of 15 T for 10 min; a second stage was performed at a temperature of 120° C. under a pressure of 20 T for 10 min; a third stage was performed at a temperature of 160° C. under a pressure of 25 T for 10 min; and a fourth stage was performed at a temperature of 180° C. under a pressure of 30 T for 10 min. Finally, the cured mixture was cooled and demolded under a pressure of 20 T to obtain the bipolar plate.

### EXAMPLE 8

Provided herein was a bipolar plate of a proton exchange membrane fuel cell, which was prepared by the following steps.

7.3 g of graphite powder was uniformly dispersed in an ethanol solution under magnetic stirring for 10 min to obtain a first mixture.

0.2 g of a Pedot electrically conductive liquid was uniformly dispersed in the ethanol solution under magnetic stirring for 35 min to obtain a second mixture; where a volume ratio of ethanol to water in the ethanol solution was 4:1.

The first mixture and the second mixture were mixed followed by magnetic stirring for 35 min while heating at 48° C. until the mixture was dried. The dried mixture was placed in an oven to further be dried to obtain a powder mixture.

Subsequently, the powder mixture and 2.5 g of phenolic resin powder were mixed through ball milling at a speed of 220 rpm for 2.5 h to obtain a third mixture.

The third mixture was placed in a mold to be subjected to thermal press curing in four stages, where a first stage was performed at a temperature of 60° C. under a pressure of 15 T for 10 min; a second stage was performed at a temperature of 120° C. under a pressure of 20 T for 10 min; a third stage was performed at a temperature of 160° C. under a pressure of 25 T for 10 min; and a fourth stage was performed at a temperature of 180° C. under a pressure of 30 T for 10 min, Finally, the cured mixture was cooled and demolded under a pressure of 20 T to obtain the bipolar plate.

### EXAMPLE 9

Provided herein was a composition for preparing an electrically conductive material, which was prepared through the following method.

8.3 g of graphite powder was uniformly dispersed in an ethanol solution under magnetic stirring for 10 min to obtain a first mixture.

0.2 g of a Pedot electrically conductive liquid was uniformly dispersed in the ethanol solution under magnetic stirring for 10 min to obtain a second mixture; where a volume ratio of ethanol to water in the ethanol solution was 4:1.

The first mixture and the second mixture were mixed followed by magnetic stirring for 10 min while heating at 40° C. until the mixture was dried. The dried mixture was placed in an oven to further be dried to obtain a powder mixture.

The powder mixture and phenolic resin powder were mixed through ball milling at a speed of 221 rpm fin 2 h to obtain the composition for preparing the electrically conductive material.

### EXAMPLE 10

Provided herein was a proton exchange membrane fuel cell using the bipolar plate prepared in Embodiment 1.

### COMPARATIVE EXAMPLE

1.5 g of phenolic resin (Type 3006, Shandong Laiwu Runda New Material Co., Ltd) and 8.5 g of graphite powder were mixed through ball milling at a speed of 221 rpm for 2 h. The obtained mixture was placed in a mold; and then the mold filled with the obtained mixture was placed on a hot press to perform thermal press curing in four stages, where a first stage was performed at a temperature of 60° C. under a pressure of 15 T for 10 min; a second stage was performed at a temperature of 120° C. under a pressure of 20 T for 10 min; a third stage was performed at a temperature of 160° C. under a pressure of 25 T for 10 min: and a fourth stage was performed at a temperature of 180° C. wider a pressure of 30 T for 10 min. Finally, the cured mixture was cooled and demolded under a pressure of 20 T to obtain the bipolar plate.

### TEST EXAMPLE

1. Samples 1) The graphite-phenolic resin composite bipolar plates prepared in Examples 1-3;

2) the electrically conductive polymer-reinforced composite bipolar plate prepared in Comparative Example.

### 2. Test Method

The bipolar plates were characterized by conductivity and strength measured according to GB/T 20042.6-2011 test method.

The test methods were specifically described as follows.

### Conductivity Test:

At least 5 parts near an edge and center of the samples were measured using a four-point probe which was capable of measuring low resistance to obtain the resistance values of different parts of the samples.

### Bending Strength Test:

A width and a thickness of each of the samples were measured with an accuracy of ±0.5%.

A span of a support of a testing machine was adjusted. Each of the prepared samples was placed on the support. An indenter of the testing machine and a support axis were perpendicular to the samples. The bending strengths of the bipolar plates were measured according to a GB/T 13465.2-2002 three-point bending method.

The indenter uniformly gently applied the load at a loading speed of 1-10 mm/min until the samples were broke, so as to obtain the breaking load.

The bending strength was calculated according to σ=(3P*L)/(2b*h²), where

σ was the bending strength (MPa);

P was the breaking load (N);

L was the span (mm) of the support;

b was the width (mm) of a sample;

h was the thickness (mm) of the sample.

3 valid samples were taken as a group, and the test results of each group were averaged to obtain calculation results, shown in Table 1.

TABLE 1
Test results

| | | Electrical | Bending |
|---|---|---|---|
| | | Conductivity | strength |
| Samples | Examples | (S/cm) | (MPa) |
| S1 | Comparative | 158 | 57 |
| | Example | | |
| S2 | Example 1 | 333 | 21 |
| S3 | Example 2 | 558 | 72 |
| S4 | Example 3 | 526 | 68 |

It should be understood that various embodiments described in the disclosure are not intended to illustrate an independent technical solution in each embodiment, but are merely intended to make the application clear. The technical solutions of the invention should be understood as a whole. Any other embodiments can be made by those skilled in the art by combining the technical solutions in different embodiments.

The inventor declares that the above descriptions are merely illustrative of the feasible implementations of the application, and the present invention is not limited to the above detailed process equipment and manufacturing process. In addition, it does not mean that the application is implemented only through these detailed process equipment and manufacturing process. It should be understood that any improvements, equivalent replacements of raw materials of the products of the application, any addition of auxiliary components and any selection of specific methods made by those skilled in the art should fall within the scope of the present application

### INDUSTRIAL APPLICABILITY

The bipolar plate of the proton exchange membrane fuel cell and the method of preparing the same provided in the application have lots of advantages and values as mentioned above. The products and preparation methods of the application are not disclosed or used in the art, and thus are inventive. The application has more functions and practical effects over the prior art, so the application is industrially applicable and has a wide range of industrial values.

What is claimed is:

1. A bipolar plate of a proton exchange membrane fuel cell, the bipolar plate being prepared from 5%-30% by weight of thermosetting resin. 60%-90% by weight of graphite powder and 1%-10% by weight of an electrically conductive polymer.

2. The bipolar plate of claim 1, wherein the bipolar plate is prepared from 10%25% by weight of the thermosetting resin, 69%-80% by weight of the graphite powder and 2%-10% by weight of the electrically conductive polymer.

3. The bipolar plate of claim 1, wherein the bipolar plate is prepared from 10%-20% by weight of the thermosetting resin, 73%-80% by weight of the graphite powder and 5%-10% by eight of the electrically conductive polymer.

4. The bipolar plate of claim 1, wherein the bipolar plate is prepared from 15%-30% by weight of the thermosetting resin, 69%-80% by weight of the graphite powder and 1%-5% by weight of the electrically conductive polymer.

5. The bipolar plate of claim 1, wherein the thermosetting resin is epoxy resin or phenol resin.

6. The bipolar plate of claim 1, wherein the electrically conductive polymer is polypyrrole, polyacetylene, polyp-phenylene) or a poly(3,4-ethylendioxythiophene) (Pedot) electrically conductive liquid.

7. A method of preparing the bipolar plate of claim 1, comprising:
1) dispersing the graphite powder in a first organic solventto obtain a first mixture;
2) dispersing the electrically conductive polymer in a second organic solvent to obtain a second mixture;
3) uniformly mixing the first mixture and the second mixture followed by heating and drying to obtain a powder mixture;
4) mixing the powder mixture and the thermosetting resin followed by ball milling to obtain a third mixture; and
5) subjecting the third mixture to thermal press curing followed by cooling and demolding to obtain the bipolar plate.

8. The method of claim 7, wherein the first organic solvent in step (1) and the second organic solvent in step (2) both are a volatile ethanol solution; and a volume ratio of ethanol to water in the ethanol solution is 4:1.

9. The method of claim 7, wherein the mixing in steps (1)-(3) is performed by magnetic stirring for 10-60 min.

10. The method of claim 7, wherein the leafing in step (3) is performed at a temperature of 40-50° C.

11. The method of claim 7, wherein the ball milling in step (4) is performed at a speed of 150-300 rpm for 1-3 h.

12. The method of claim 7, wherein in step (5), the third mixture is placed on a hot press to perform the thermal press curing; and
the thermal press curing is performed at a temperature of 150-200° C. under a pressure of 20-40 T for 10-40 min.

13. The method of claim 7, wherein the thermal press curing for the third mixture in step (5) is performed by stages.

14. The method of claim 13, wherein the thermal press curing for the third mixture in step (5) comprises four stages, wherein a first stage is performed at a temperature of 50-70° C. under a pressure of 12-18 T for 8-15 min; a second stage is performed at a temperature of 100-140° C. under a pressure of 18-22 T for 8-15 min; a third stage is performed at a temperature of 150-170 C. under a pressure of 22-28 T for 8-15 min; and a fourth stage is performed at a temperature of 170-200° C. under a pressure of 28-40 T for 8-15 min.

15. The method of claim 7, wherein the bipolar plate is prepared from 10%-25% by weight of the thermosetting resin, 69%-80% by weight of the graphite powder and 2%-10% by weight of the electrically conductive polymer.

16. The method of claim 7, wherein the bipolar plate is prepared from 10%-25% by weight of the thermosetting resin, 73%-80% by weight of the graphite powder and 5%-10% by weight of the electrically conductive polymer.

17. The method of claim 7, wherein the bipolar plate is prepared from 15%-30% by weight of the thermosetting resin, 69%-80% by weight of the graphite powder and 1%-5% by weight of the electrically conductive polymer.

18. The method of claim 7, wherein the thermosetting resin is epoxy resin or phenol resin.

19. The method of claim 7, wherein the electrically conductive polymer is polypyrrole, polyacetylene, poly(p-phenylene) or a poly(3,4-ethylendioxythiophene) (Pedot) electrically conductive liquid.
